(19) United States
(12) Patent Application Publication
(10) Pub. No.: US 2005/0223081 A1
(43) Pub. Date: Oct. 6, 2005

(54) PORTAL INCLUDING DETACHABLE AND REATTACHABLE PORTLETS

(76) Inventors: Paul F. McMahan, Apex, NC (US); Steven P. Kim, Raleigh, NC (US); Patrick R. Guido, Cary, NC (US); Robert C. Leah, Cary, NC (US)

Correspondence Address: MOORE & VAN ALLEN, PLLC, P.O. Box 13706, Research Triangle Park, NC, 27709, US

(21) Appl. No.: 10/708,971

(22) Filed: Apr. 5, 2004

(51) Int. Cl. G06F 15/16

(52) U.S. Cl. 709/218; 709/217; 709/203

(57) ABSTRACT

A portal may include at least one detachable portlet and a detach feature included in the at least one detachable portlet. In another embodiment, a method to detach and reattach at least one portlet to a portal may include detaching a selected portlet in response to activating a detach feature. The method may also include reattaching the detached portlet in response to activating a reattach feature. The selected, detached portlet may be transferred to a window in response to activating the detach feature.

### BACKGROUND OF INVENTION

The present invention relates to portals and portlets forming a portal and more particularly to a to a potlet pop-out or portlet detach feature and portlet reattach feature and a method and system to detach and reattach a portlet to a portal.

Portlets are a series of related tasks or portal applications presented to a user in a web page of a portal environment. Portlets are usually depicted as small boxes in a web page or portal. Portlets are reusable components that may provide access to applications, web-based content, and other resources. Web pages, web services, applications, and syndicated content feeds may be accessed through portlets. Any particular portlet may be developed, deployed, managed, and displayed independent of other portlets. Administrators and end users may create personalized portal pages by choosing and arranging portlets to form a desired web page format or look and feel. There is no limit to the number of portlets that may be presented to a user accessing the web page or portal. Portlets are heavily ingrained within the context of a web page and currently cannot be separated from the context of the associated portal or web page. As a result of portlets typically being tightly grouped within a portal page, information, navigation, and screen real estate all begin to diminish proportionally to the number of portlets added to a page. A portal user may encounter difficulty interacting with a large number of portlets because of horizontal and vertical scrolling that may be necessary to completely view some portlets. Such scrolling may be aggravating to a user when navigating in a crowded, cluttered or “busy” page. Additionally, a user may be overwhelmed and frustrated by the volume of content and not be able to efficiently locate or access a desired service or information, if able to access or locate such information or service at all. Further, the user may not be able to simplify the web page or portal to provide easier access and ability to locate information and services of most interest or that may be accessed on a recurring basis.

### SUMMARY OF INVENTION

In accordance with an embodiment of the present invention, a portal may include at least one detachable portlet. The portal may also include a detach feature or element associated with the at least one detachable portlet.

In accordance with another embodiment of the present invention, a method to detach and reattach at least one portlet associated with a portal may include detaching a selected portlet from the associated portal in response to activating a detach feature or element. The method may also include reattaching the detached portlet to the associated portlet in response to activating a reattach feature or element.

In accordance with another embodiment of the present invention, a method to detach and reattach at least one portlet associated with a portal may include detaching a selected portlet associated with the portal in response to activating a detach feature or element. The method may also include transferring the selected, detached portlet to a separate window or page in response to detaching the selected portlet.

In accordance with another embodiment of the present invention, a method to form a portal may include forming at least one portlet with a detach feature. The method may also include forming the portal including the at least one portlet with the detach feature.

In accordance with another embodiment of the present invention, a system to detach and reattach a portlet to a portal may include a portal server. The system may also include at least one portlet contained in the portal server. The at least one portlet may include a detach feature to detach the at least one portlet from an associated portal.

In accordance with another embodiment of the present invention, a computer-readable medium have computerexecutable instruction for performing a method that may include detaching a selected portlet from a portal in response to activation of a detach feature. The method may also include reattaching the detached portlet in response to activation of a reattach feature.

### BRIEF DESCRIPTION OF DRAWINGS

FIG. 1 is a flow chart of an exemplary method to form a portal and to detach at least one portlet associated with the portal in accordance with an embodiment of the present invention.

FIG. 2 is a flow chart of an exemplary method to reattach a portlet associated with a portal in accordance with an embodiment of the present invention.

FIGS. 3A, 3B and 3C illustrate an example of sequentially detaching and reattaching a portlet to an associated portal in accordance with an embodiment of the present invention.

FIG. 4 is an example of a system to present a portal to a user and to provide the ability for the user to detach and reattach selected portlets to an associated portal in accordance with an embodiment of the present invention.

### DETAILED DESCRIPTION

The following detailed description of preferred embodiments refers to the accompanying drawings, which illustrate specific embodiments of the invention. Other embodiments having different structures and operations do not depart from the scope of the present invention.

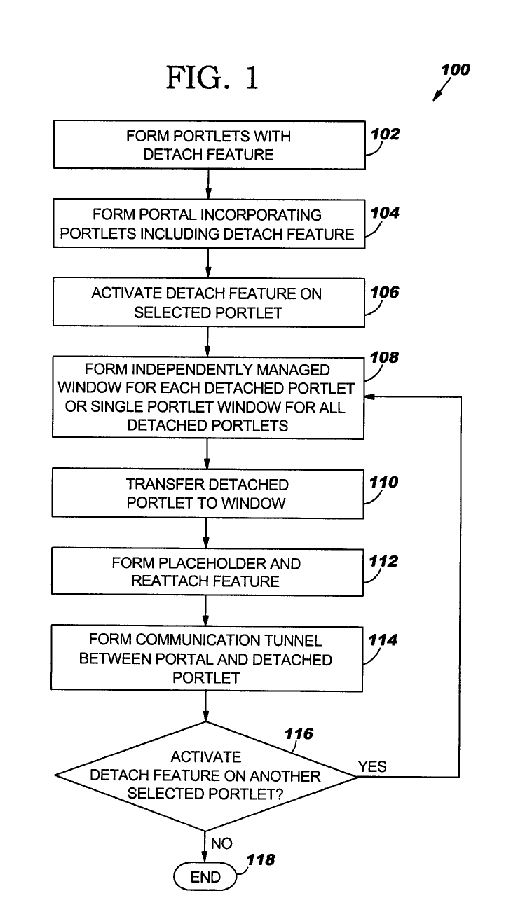

FIG. 1 is a flow chart of an exemplary method 100 to form a portal and to detach at least one portlet associated with the portal in accordance with an embodiment of the present invention. In block 102 one or more portlets may be formed including a detach feature or element. The portlets may be formed or written using a web-based programming language, such as Java™, hypertext markup language (HTML) or the like. The detach feature may include an icon or other graphical symbol representative of a feature or function to pop-out, undock or detach an associated portlet from a portal in which the portlet is being presented. Detaching a portlet may effectively remove the portlet from the portal. As discussed in more detail below, the portlet when detached or popped-out may be represented in the portal by a small placeholder or symbol representative of the portlet. Detaching one or more portlets makes the portal less crowded or cluttered and provides more space in the portal for other portlets that may be more useful to a particular user. Detaching one or more portlets may also make the portal easier to navigate.

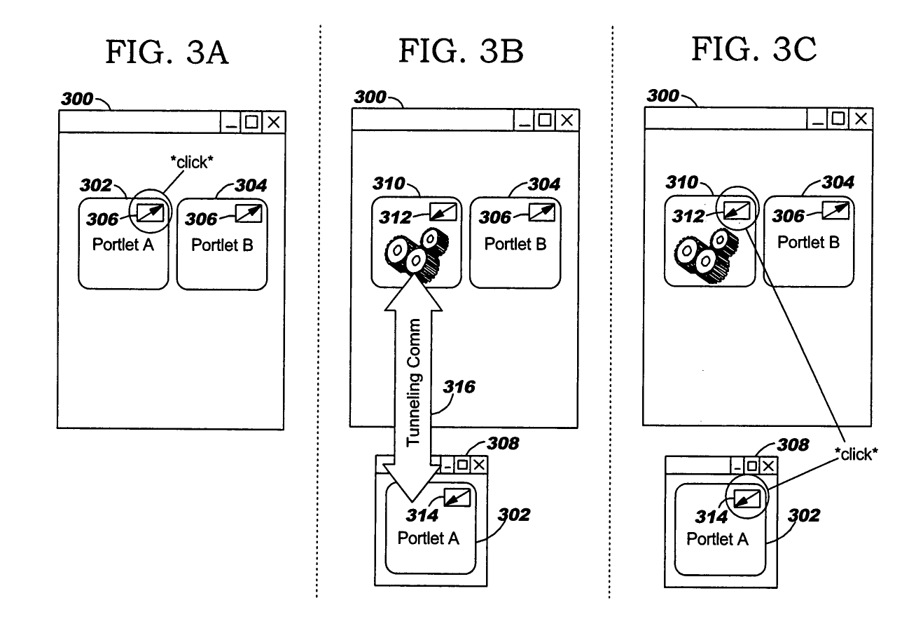

In block 104, a portal may be formed incorporating one or more portlets that include a detach feature or element. The portal may also include other portlets that do not have the detach feature. Referring also to FIG. 3A, FIG. 3A illustrates an example of a portal 300 including a plurality of portlets, portlet A 302 and portlet B 304. Each portlet 302 and 304 may include a detach function 306 or element. In block 106 (FIG. 1), the detach feature or element (element 306 in FIG. 3A) may be activated by a user clicking on the icon or symbol using a mouse or other pointing device.

In block 108, an independently managed window or page may be formed in response to the detach feature 306 being activated. Forming independently managed windows or pages is known by those skilled in the art. An independently managed window may be formed or created for each detached portlet. Alternatively, one or more portlet windows or pages may be formed to retain all detached portlets depending upon the quantity and size of the detached portlets and the number of windows needed to retain or house the detached portlets. In block 110, the detached portlet may be transferred to the independently managed window or page. In block 112, a placeholder may be formed in the portal to represent and hold the place for the detached portlet. The placeholder may be substantially smaller than the original portlet because of less content to occupy much less space or real estate in the portal and to unclutter the portal. The placeholder may also include a reattach feature or element that may be operated or activated to reattach or transfer the contents of the portlet back into the portal. The reattach feature or element may include an icon or symbol representative of the function of transferring the contents of the portlet back into the portal. Thus, the contents of the popped-out or detached portlet may be replaced with a placeholder including a reattach function or icon within the portal page. In block 114, a communication tunnel or tunneling communication may be established or formed between the portal or placeholder and the detached portlet. Accordingly, communication with the detached portlet through the portal may continue.

Referring also to FIG. 3B, FIG. 3B illustrates portlet A 302 being detached or popped-out of the portal page 300. Portlet A 302 and its contents may be transferred to an independently managed window or page 308 or the like and a placeholder 310 may replace portlet A 302 in the portal page 300. The placeholder 310 may include a reattach element or feature 312. The detached portlet A 302 in the window 308 may also include a reattach element or feature 314. Tunneling communication 316 may be created or established between the detached portlet A 302 and the placeholder 310 or portal 300.

Referring back to FIG. 1, in block 116, a determination may be made if a detach feature has been activated on any other portlets. If so, the method 100 may return to block 108 and the method 100 may continue as previously described with respect to blocks 108-116. If the detach feature or element has not been activated for any other selected portlets, the method 100 may end at termination 118.

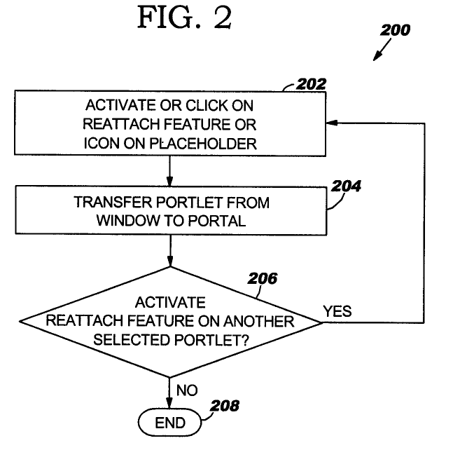

FIG. 2 is a flow chart of an exemplary method 200 to reattach a portlet associated with a portal in accordance with an embodiment of the present invention. In block 202, a reattach feature or element may be activated by clicking on a reattach icon or symbol on the placeholder or on the detached portlet in the independently managed page. Referring also to FIG. 3C, FIG. 3C illustrates an example of activating the reattach feature or element by clicking on a reattach icon or symbol 312 on the placeholder 310 or clicking on a reattach icon or symbol 314 on the detached portlet A 302.

In block 204, the detached portlet may be transferred from the independently managed window or page back to the portal page. In block 206, a determination may be made if a reattach feature has been activated on another selected, detached portlet. If a reattach feature has been activated on another detached portlet, the method 200 may return to block 202 and the method may proceed as previously described with respect to blocks 202-206. If a reattach feature has not been activated on any other detached portlets, the method 200 may end at termination 208 until a reattach feature is activated.

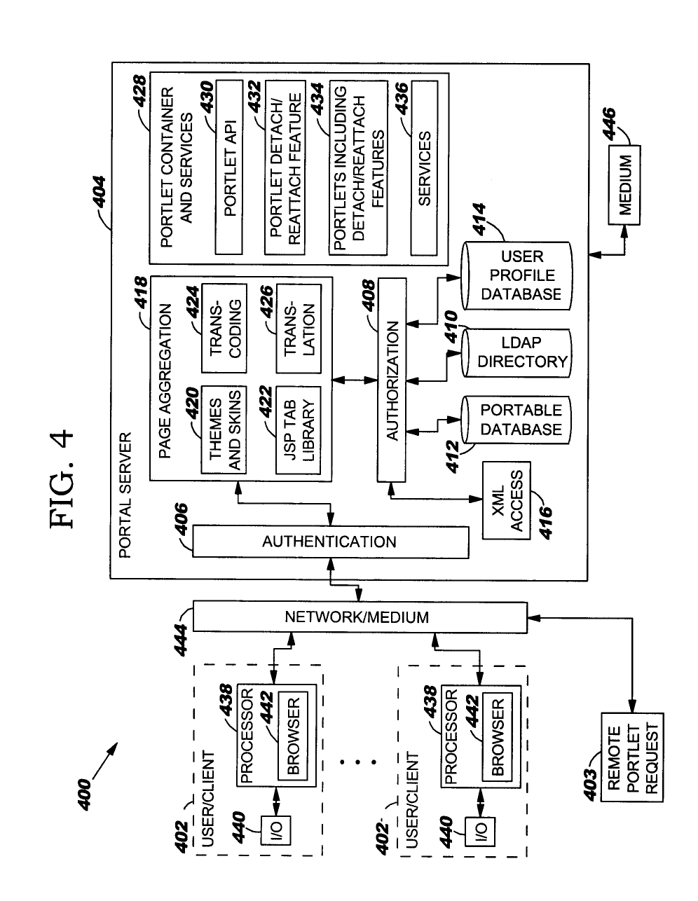

FIG. 4 is an example of a system 400 to present a portal to one or more users or clients 402 and to provide the ability for the user 402 to detach and reattach selected portlets to an associated portal in accordance with an embodiment of the present invention. The user or client 402 may be a desktop or mobile computing system, cellular telephone, personal digital assistance or the like. The system 400 may also be accessed by a remote portlet request 403 from another server or system. Elements of the methods 100 and 200 of FIGS. 1 and 2 may be embodied in the system 400. The system 400 may include a portal server 404. The portal server 404 may provide common services, such as application connectivity, integration, administration, and presentation capabilities that may be needed across all portal environments. The portal server 404 may include an authentication element 406 to establish a user's identity. The portal server 404 may use form-based authentication. In form-based authentication, a user may be prompted through an HTML form or the like to enter a user ID and password for authentication when trying to access a particular portal. After receiving the user's identification and password information, the portal server 404 may validate the authentication information via an authorization element 408. The portal server 404 may validate the authentication information against information contained in a Lightweight Directory Access Protocol (LDAP) directory 410. The authorization element 408 or process may also determine which pages or portlets a user has permission to access. The authorization element 408 may access the LDAP directory 410, portal database 412, and user profile database 414 in determining proper authentication, which portals are accessible by the user and other privileges or settings. The authorization element 408 may also interface with an extensible markup language (XML) access element 416.

The portal server 404 may also include a page aggregation element 418. Components of the page aggregation element 418 may be embodied in hardware or software. The page aggregation element 418 may include a themes and skins module 420. Users may be able to customize or personalize pages including for example, a choice of color themes, skins and page layouts. Themes may be used to define fonts, colors, spacing and other visual elements. Themes may consist of cascading style sheets, Java Script Page (JSP) files, images or the like. Skins may be decorations and controls placed around portlets, such as title bars, borders, shadows, or similar treatments. The page aggregation element 418 may also include a JSP tab library 422, transcoding module 424 and translation module 426 to further facilitate portal customization and presentation of the portal and portlets to the user 402.

The portal server 404 may also include a portlet container and services element 428. Components of the portlet container and services element 428 may be embodied in hardware or software. The portlet container and service element 428 may include a portlet Application Programming Interface (API) 430. Portlets rely on portal infrastructure to access user profile information, participate in window and action events, communicate with other portlets, access remote content, lookup credentials, store persistent data and perform other functions. The portlet API 430 provides standard interfaces for these functions or services.

The portlet container and services module 428 may also include a portlet detach/reattach feature 432 and portlets 434 or information to form portlets. The portlet detach/reattach feature 432 may be the same as methods 100 and 200 of FIGS. 1 and 2. The portlets 434 may include portlets having detach and reattach features and portlets without. The portlet container and services module 428 may also include other services or functions 436. Examples of other services or functions 436 may include, but is not limited to, content access, web page clipping, searching, document administration, portlet proxy, single signon and the like.

Each user 402 or client may include a processor 438 and input/output devices 440. A browser or web browser 442 may operate on the processor 438 to facilitate accessing the portal server 404. The input/output devices 440 may include separate input devices, output devices or combination input/output devices. The input/output devices 440 may include a keyboard, pointing device, voice recognition system or the like. The input/output devices 440 may also include optical, magnetic, infrared or radio frequency devices, disk drives or the like. The input devices 440 may receive read or download software, computer-executable or readable instructions or the like, such as software that may embody elements of the methods 100 and 200 of FIGS. 1 and 2.

Each user 402 may access the portal server 400 via a communication network or medium 444. The communication network or medium 444 may be any communication system including by way of example, dedicated communication lines, telephone networks, wireless data transmission systems, two-way cable systems, customized computer networks, interactive kiosk networks, the Internet and the like.

Elements of the present invention, such as methods 100 and 200 of FIGS. 1 and 2 respectively, and system 400 of FIG. 4, may be embodied in hardware and/or software as a computer program code that may include firmware, resident software, microcode or the like. Additionally, elements of the invention may take the form of a computer program product on a computer-usable or computer-readable storage medium having computer-usable or computer-readable program code embodied in a medium for use by or in connection with a system, such as system 400 of FIG. 4. Examples of such a medium may be illustrated in FIG. 4 as I/O devices 440 or medium 446. A computer-usable or readable medium may be any medium that may contain, store, communicate or transport the program for use by or in connection with a system. The medium, for example, may be an electronic, magnetic, optical, electromagnetic, infrared or semiconductor system or the like. The medium may also be simply a stream of information being retrieved when the computer program product is “downloaded” through a network, such as the Internet or the like. The computer-usable or readable medium could also be paper or another suitable medium upon which the program may be printed.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. A portal, comprising:
at least one detachable portlet; and
a detach feature associated with the at least one detachable portlet.

2. The portal of claim 1, wherein the detach feature comprises an icon to transfer the at least one detachable portlet to an independently managed window in response to the icon being activated.

3. The portal of claim 1, further comprising a window to receive a detached portlet in response to activating the detach feature.

4. The portal of claim 3, wherein the window is an independently managed window.

5. The portal of claim 3, further comprising a placeholder formed in the portal to represent the detached portlet.

6. The portal of claim 5, wherein the placeholder comprises a reattach feature to reattach the detached portlet to the portal in response to activating the reattach feature.

7. The portal of claim 5, further comprising a communication tunnel formable between the placeholder and the detached portlet.

8. The portal of claim 3, wherein the detached portlet comprises a reattach feature to reattach the detached portlet in response to activating the reattach feature.

9. The portal of claim 3, further comprising:
a placeholder formed in the portal to represent the detached portlet;
a reattach feature to reattach the detached portlet to the portal in response to activating the reattach feature; and
another reattach feature formed in the detached portlet to reattach the detached portlet in response to the other reattach feature being activated.

10. The portal of claim 1, further comprising tunneling communication between the portal and any detached portlets.

11. A method to detach and reattach at least one portlet associated with a portal, comprising
detaching a selected portlet in response to activating a detach feature; and
reattaching the detached portlet in response to activating a reattach feature.

12. The method of claim 11, further comprising transferring the selected, detached portlet to a window in response to activating the detach feature.

13. The method of claim 11, further comprising forming an independently managed window for each detached portlet.

14. The method of claim 11, further comprising forming a single portlet window for all detached portlets.

15. The method of claim 11, further comprising forming a placeholder in the portal for each detached portlet.

16. The method of claim 15, further comprising forming the reattach feature on at least one of each placeholder and each detached portlet.

17. The method of claim 16, further comprising transferring a detached portlet from the window to the portal in response to activating the reattach feature.

18. The method of claim 11, further comprising forming a communication tunnel between the portal and the detached portlet.

19. A method to detach and reattach at least one portlet associated with a portal, comprising:
detaching a selected portlet in response to activating a detach feature; and
transferring the selected, detached portlet to a window in response to detaching the selected portlet.

20. The method of claim 19, further comprising forming an independently managed window for each detached portlet.

21. The method of claim 19, further comprising forming a placeholder in the portal for each detached portlet.

22. The method of claim 21, further comprising forming a reattach feature on at least one of each placeholder and each detached portlet.

23. The method of claim 19, further comprising transferring the detached portlet from the window to the portal in response to activating a reattach feature.

24. A method to form a portal, comprising:
forming at least one portlet with a detach feature; and
forming the portal including the at least one portlet with the detach feature.

25. The method of claim 24, further comprising providing a window to receive each detached portlets.

26. The method of claim 24, further comprising providing a window to receive all detached portlets.

27. The method of claim 24, further comprising providing an independently managed window to receive each detached portlet.

28. The method of claim 27, further comprising providing a reattach feature associated with each detached portlet.

29. The method of claim 27, further comprising providing a placeholder in the portal for each detached portlet.

30. The method of claim 29, further comprising providing a reattach feature associated with at least one of each detached portlet and an associated placeholder.

31. The method of claim 29, further comprising providing tunneling communication between each placeholder and an associated detached portlet.

32. The method of claim 24, further comprising providing tunneling communication between the portal and each detached portlet.

33. A system to detach and reattach a portlet to a portal, comprising:
a portal server; and
at least one portlet contained on the portal server, wherein the at least one portlet includes a detach feature to detach the at least one portlet from an associated portal.

34. The system of claim 33, further comprising a reattach feature associated with each detached portlet to reattach the detached portlet to the associated portal.

35. The system of claim 33, further comprising means to provide a window to receive each detached portlet.

36. The system of claim 35, wherein the window is an independently managed window.

37. The system of claim 33, further comprising means to provide tunneling communication between each detached portlet and the associated portal.

38. The system of claim 33, further comprising a placeholder for each detached portlet in the associated portal.

39. The system of claim 33, further comprising a reattach feature associated with at least one of each detached portlet and the associated portal.

40. The system of claim 33, further comprising a portlet container to contain the at least one portlet on the portal server.

41. The system of claim 33, further comprising a page aggregation element to organize and present the at least one portlet to a user on the associated portal.

42. A computer-readable medium having computer-executable instructions for performing a method, comprising:
detaching a selected portlet from a portal in response to activation of a detach feature; and
reattaching the detached portlet in response to activation of a reattach feature.

43. The computer-readable medium having computer executable instructions for performing the method of claim 42, further comprising transferring the selected, detached portlet to a window in response to activating the detach feature.

44. The computer-readable medium having computer executable instructions for performing the method of claim 42, further comprising forming an independently managed window for each detached portlet.

45. The computer-readable medium having computer executable instructions for performing the method of claim 42, further comprising forming a placeholder in the portal for each detached portlet.

46. The computer-readable medium having computer executable instructions for performing the method of claim 45, further comprising forming the reattach feature on at least one of each placeholder and each detached portlet.

47. The computer-readable medium having computer executable instructions for performing the method of claim 46, further comprising transferring a detached portlet from the window to the portal in response to activating the reattach feature.

48. The computer-readable medium having computer executable instructions for performing the method of claim 42, further comprising forming tunneling communication between the portal and the detached portlet.
